(19) United States
(12) Patent Application Publication
(10) Pub. No.: US 2026/0084587 A1
(43) Pub. Date: Mar. 26, 2026

(54) CONTROL METHOD FOR A VEHICLE SEAT, AND VEHICLE SEAT

(71) Applicant: Adient US LLC, Plymouth, MI (US)

(72) Inventors: Kirubaharan ALBERT REGINOLD, Burscheid (DE); Grit SCHOLZ, Remscheid (DE); Karthikeyan Maharajapuram SUBRAMANIAN, Leverkusen (DE); Thomas SOTA GARRIDO, Solingen (DE); Jürgen OTTO, Leverkusen (DE); Markus GUMBRICH, Solingen (DE)

(21) Appl. No.: 19/336,616

(22) Filed: Sep. 23, 2025

(30) Foreign Application Priority Data
Sep. 23, 2024 (DE) 10 2024 209 118.9

(51) Int. Cl. B60N 2/02; B60N 2/06

(52) U.S. Cl. CPC B60N 2/0244; B60N 2/02253; B60N 2/06

(57) ABSTRACT

A control method for a vehicle seat may have an adjustment device for adjusting a first seat component relative to a second seat component. The adjustment device may have an adjustment mechanism and at least one setting fitting that is driven by a drive device. The adjustment mechanism may be configured to generate an adjustment movement of the first seat component relative to the second seat component. In order to compensate for nonuniform transmission of the adjustment device, the drive device may be controlled by a control device in such a way that a nonuniform drive movement generated by the drive device is transmitted to the setting fitting and the setting fitting generates a determined output movement of the adjustment device and thus effects a determined adjustment movement of the first seat component. A vehicle seat controllable according to the control method is also provided.

### FIELD

The invention relates to a control method for a vehicle seat, and to a vehicle seat having an adjustment device.

### BACKGROUND

DE 100 42 851 A1 discloses a height-adjustable underframe of a motor vehicle seat, having a left-hand and a right-hand rail pair of a longitudinal adjustment apparatus and having a left-hand and a right-hand side part, each of which is articulated via a rear and a front swing arm to the associated seat rail of the rail pair, wherein provision is made of a setting arm which, by way of a lower end region, is articulated at a point of articulation of a rear swing arm to the associated seat rail and which, in the vicinity of its upper end, is fixed in a releasable manner in a locking apparatus that is fastened to the associated side part.

The market share of electrically settable seats is currently increasing enormously. To this end, there is a need for transmissions which, by contrast to so-called “rasters”, operate continuously and can thus be motor-driven. In light of ever-increasing demands on comfort, features such as seat inclination setting, calf support adjustment or seat height settings, both in front and rear seat backrests, are increasingly being electrified, preferably being realized electrically via remote control or mobile phone app and at a significantly greater speed than in the case of comfort settings for achieving a comfortable sitting position for the seated person. The further development of autonomous vehicles that is taking place in parallel furthermore requires an extended setting range of the seats, in order to also provide comfort for the occupants, who are no longer constantly in control of the steering. With the simultaneous need to maintain occupant safety in the event of an accident, this means that the safety belt must be moved completely with the seat in order to lie closely against the person even if the seats or backrests have been positioned far rearward. Such belt systems, the shoulder belt of which is therefore no longer fastened to the B-pillar so as to be fixed with respect to the vehicle body but is fastened in the upper region of the backrest, lead to significantly higher loads in the complete load flow through the seat and accordingly through the seat setting transmission.

WO 2021/084 067 A1 has presented a central transmission which, for achieving a non-wobbling setting movement and the return of the two 180°-offset wobbling toothed parts to a backrest movement running concentrically with respect to the bottom part, contains a concentrically mounted internal gear, later fixed with respect to the backrest, which is in engagement with both 180°-offset wobbling gearwheels such that, for example, one gearwheel is in toothed engagement with the internal gear at the top and one gearwheel is in toothed engagement with the internal gear at the bottom. The phase shift by 180° of two sinusoidal torque curves, which in combination result in an almost constant linear profile of the torque required from the motor, results in uniform acoustic behavior being achieved. The disadvantage here is the complex structure composed of five toothed parts.

The simultaneous demand for weight optimization and freedom from play with maximum strength suggests that the so-called wobble transmission is used in the setting means, said wobble transmission consisting as a “simple open planetary transmission” only of one transmission stage and thus only of two toothed parts (for example DE 10 2011 113 748 B4) and consequently being able to, in a small installation space, accommodate very high loads and be set free of play while having a cost-optimized construction. In the case of this “simple open planetary transmission” transmission solution, the output movement relative to the fixed drive point of rotation is not a centered movement, but rather the output drive follows a discontinuous movement. During the adjustment travel, fast and slow travel sections alternate. This wobbling movement is being criticized more and more by the customer. The modulation of motor noise brought about by the discontinuous movement and torque variations is also detrimental and undesirable.

Further adjustable vehicle seats are known from WO 2023/021 223 A1, DE 10 2019 211 169 A1 and DE 103 41 001 B3.

### SUMMARY

The invention is based on the object of improving a control method for a vehicle seat and a vehicle seat of the type mentioned in the introduction with regard to the adjustment thereof, in particular in order to increase comfort for occupants. The described boundary conditions for electrical setting fittings result in the object of finding a solution for a constant movement for the desired seat function with the installation of a wobble-type setting means.

The first-mentioned object is achieved according to the invention by a control method having the features of claim 1. The second-mentioned object is achieved according to the invention by a vehicle seat having the features of claim 10.

The first-mentioned object is achieved according to the invention by a control method for a vehicle seat having an adjustment device for adjusting a first seat component relative to a second seat component, wherein the adjustment device comprises an adjustment mechanism and at least one setting fitting that is able to be driven by a drive device, wherein the adjustment mechanism is connected operatively to the first seat component and the second seat component and is configured to generate during the operation of the drive device an adjustment movement of the first seat component relative to the second seat component, and, in order to compensate for nonuniform transmission of the adjustment device, the drive device is controlled by a control device in such a way that a nonuniform drive movement generated by the drive device is transmitted to the setting fitting and the setting fitting generates a determined, that is to say defined or selectable, output movement of the adjustment device and thus effects a determined, that is to say defined or selectable, adjustment movement of the first seat component.

The adjustment mechanism and the at least one setting fitting of the adjustment device together form a kinematic transmission mechanism of the vehicle seat. The drive device is controlled by the control device in such a way that nonuniformity in the kinematic transmission mechanism is compensated.

In other words, the invention teaches to generate a nonuniform drive movement in order to compensate for a nonuniform transmission behavior of the setting device and to perform a specific setting movement of the first seat component relative to the second seat component.

The invention permits a precise and predictable adjustment movement of the first seat component relative to the second seat component, even in the case of a nonuniform transmission characteristic (also referred to as nonuniform transmission behavior) of the adjustment device. This is achieved in that the drive device is controlled or controllable in such a way that it generates a nonuniform drive movement that compensates for the nonuniformity in the transmission, whereby a determined output movement of the setting fitting results and is generated. In this way, the adjustment of the seat component is controlled in an exact manner, improving the reliability and comfort of seat positioning in the vehicle.

The control device is configured to actively control the drive device so as to compensate for nonuniform transmission of the adjustment device, such that a nonuniform drive movement generated by the drive device is transmitted to the setting fitting and the setting fitting generates a determined output movement of the adjustment device and thus effects a determined adjustment movement of the first seat component.

In particular, the drive device is controlled directly by the control device in such a way that said drive device generates a nonuniform drive movement.

The adjustment mechanism, the setting fitting and the adjustment device as a totality of the adjustment mechanism and one or more setting fittings is in each case a transmission unit. In transmission units, movement is transmitted according to a transmission function that relates an output parameter, for example a displacement sₒᵤₜ, as an adjustment movement of the first seat component relative to the second seat component, to a drive parameter, for example a rotation angle φᵢₙ, as a drive movement of a drive device, for example an electric motor. If the transmission function is linear, that is to say is in the form sₒᵤₜ=C·φᵢₙ, a uniformly transmitting transmission is involved, that is to say the output parameter is proportional to the drive parameter. The proportionality factor C is a constant and is referred to as the transmission ratio of the transmission.

By contrast, nonuniformly transmitting transmissions have a transmission function of the general form sₒᵤₜ=f(φᵢₙ). Specifically, such a transmission function is generally a nonlinear mathematical relationship between the drive parameter and the output parameter. The movement sequence of the majority of these transmissions is repeated at fixed intervals, for example in each case after a full revolution of the drive shaft. Said nonuniformly transmitting transmissions consequently have a periodic transmission function. The greater the number of nonuniformly transmitting subcomponents interacting in an overall system, the more complex the transmission function thereof becomes.

In association with the present invention, a nonuniformly transmitting adjustment mechanism is intended to be understood as meaning a nonuniformly transmitting transmission which does not proportionally convert the drive parameter, that is to say the drive movement of the drive device, into the output parameter, that is to say the output movement of the adjustment mechanism that effects the adjustment movement of the first seat component. The nonuniform transmission in this case may be completely or partly attributable to the transmission behavior of the adjustment mechanism and/or completely or partly attributable to the to the setting fitting(s).

A setting fitting with nonuniform transmission in the above sense may for example be a wobble transmission (also referred to as wobble fitting or wobble setting fitting), which may for example be in the form of a simple open planetary transmission. An adjustment mechanism with nonuniform transmission may for example be in the form of a four-member coupling mechanism of an adjustment device for height setting and/or inclination setting of the vehicle seat. In particular in association with one or more nonuniformly transmitting setting fittings, the output parameter is a nonuniform adjustment movement of the first seat component relative to the second seat component, for example the backrest relative to the seat part of the vehicle seat, the seat part relative to a rail arrangement by way of which the vehicle seat is fastened to the vehicle floor, and so on, if use is made of a uniform drive parameter, for example a rotation at a constant angular speed of a drive shaft of the drive device. This can result in the adjustment movement being perceived as unpleasant by a user.

A basic concept of the invention is to generate a nonuniform drive movement in a targeted manner by way of the drive device of at least one setting fitting, for example a servo motor, in such a way that, owing to the nonuniform transmission behavior of the setting fitting, a determined, that is to say fixed or selectable, adjustment movement of the first seat component relative to the second seat component is nonetheless achieved.

In this context, “determined” is intended to mean that the output movement of the setting fitting or the resulting adjustment movement of the first seat component relative to the second seat component has a predefined form of movement or a form of movement selectable by a user, for example a form of movement selectable from a plurality of predefined forms of movement. That is to say, irrespective of the transmission behavior of the adjustment mechanism and/or of the setting fitting, an arbitrarily definable form of movement can be generated for the adjustment movement of the first seat component. For example, the determined adjustment movement may comprise a uniform form of movement in which an output parameter, for example an adjustment travel or an adjustment angle, changes at a constant rate or at a constant angular rate, that is to say uniformly. However, other forms of movement, for example starting ramps or braking in the vicinity of the end stop or a uniformly accelerated output movement, are also covered by the concept of the invention and achievable by way of the proposed method, so that slower movement is carried out in the setting ranges for large, heavy persons than in those for small, generally lighter, persons, or any other forms of movement.

In this way, it is possible to use an inexpensive and lightweight wobble transmission as a setting fitting and at the same time to achieve a high level of operating convenience. A possible influence of the adjustment mechanism itself on the nonuniform transmission behavior of the overall system, composed of adjustment mechanism and setting fitting or setting fittings, can in this way be eliminated too.

Advantageous configurations, which may be used individually or in combination with one another, are the subject matter of the dependent claims.

In configurations of the invention, the drive device may be controlled for example by means of pulse width modulation in order to generate the required nonuniform drive movement. Pulse width modulation converts a digital signal into an analog signal by changing the times for the switched-on and switched-off durations. The duty cycle describes the ratio between switched-on duration and switched-off duration and determines the rotational speed of the drive device. A PWM-modulated signal can be easily generated in electronic control devices.

It may be provided for example that target values of the nonuniform drive movement are stored in the control device in the form of a lookup table in a manner dependent on actual values of the determined output movement and are used for controlling the drive device to generate the required nonuniform drive movement. Lookup tables can be easily stored in electronic control devices. They render unnecessary calculations of the target values at the time of operation of the adjustment device.

In another configuration of the control method, it may be provided for example that actual values of the determined adjustment movement are ascertained from sensors of the drive device. This may be particularly advantageously applied where the drive device is a servo motor. Servo motors are electric motors that can precisely control the position, rotational speed and acceleration of the shaft thereof, thus allowing precise movement control. Servo motors consist of an electric motor, a position sensor and a controller. The electric motor generates a torque which rotates the shaft of the motor. The position sensor measures the position of the shaft and passes this information on to the controller. The controller compares the measured position with the desired position and controls the electric motor so that the desired position is reached.

For example, the drive device may be controlled on the basis of an inverse transmission function for the setting fitting and/or for the adjustment mechanism. If the transmission function of the adjustment device is known, this can be inverted in order to use the inverted function to obtain, with the specification of a determined output movement, target values for the control of the drive device.

For example, it may be provided that the inverse transmission function is ascertained by a numerical simulation for the setting fitting and/or the adjustment mechanism in which, on the output side, a determined output movement is specified as an input variable and, on the drive side, target values of the nonuniform drive movement are obtained as an output variable. Software is available for performing such simulations. This simulation is required only once for each adjustment device according to the kinematics of the adjustment mechanism and the used setting fittings and the situation regarding the installation thereof by the manufacturer, and the results thereof can later be used in all adjustment devices of the same type, for example by storing a corresponding lookup table in the control device.

In one refinement, it may be provided for example that the drive devices are controlled by at least two nonuniformly transmitting setting fittings, which are constituent parts of the same adjustment mechanism, in such a way that, aside from the nonuniform transmission of one setting fitting, the nonuniform transmission of every other setting fitting and possibly of the adjustment mechanism itself is also compensated. This makes it possible in a simple manner to effectively compensate for even extremely complicated nonuniform transmission behavior.

The object is moreover achieved according to the invention by a vehicle seat having an adjustment device for adjusting a first seat component relative to a second seat component, wherein the adjustment device comprises at least one setting fitting with nonuniform transmission able to be driven by a drive device, which, as a constituent part of an adjustment mechanism, is connected operatively to the first seat component and the second seat component and is configured to generate during the operation of the drive device an adjustment movement of the first seat component relative to the second seat component, wherein the adjustment device comprises a control device, or is connected operatively to a control device, which, in order to compensate for nonuniform transmission of the adjustment device, controls the drive device with a control method in such a way that a nonuniform drive movement generated by the drive device is transmitted to the setting fitting and the setting fitting generates a determined output movement of the adjustment device and thus effects a determined adjustment movement of the first seat component.

Particularly advantageous configurations of the proposed vehicle seat may be provided by the control method being configured as described in detail above.

In summary, and put differently, the invention provides a control method for vehicle seats by way of which a determined, that is to say fixed or selectable, adjustment movement that is more uniform in comparison with the prior art or is approximately uniform, for example, can be generated.

The core concept presented here for solving the described problem is a profile of the motor rotational speed that is predefined and set in a targeted manner in such a way that the seat setting function is realized either continuously or according to any other desired profile even if a wobble transmission is used. For this purpose, use may be made for example of the fact that a fixed assignment of the motor rotations to the angle positions of the drive shaft of a wobble setting fitting that are realized via transmission from the motor transmission can be ascertained via a count of the Hall pulses, said assignment always being provided irrespective of rotational speed, motor voltage or load torque.

The position and the profile of the modulation can be determined and influenced by fixing the installation position of the wobble setting fitting. According to the kinematics of the setting fitting, which may for example be a four-member coupling mechanism of a height setting means and/or inclination setting means, an assumed external load and constant drive speed result in a calculable and measurable graph of the output speed at the functional element, for example for the inclination of the cushion shell at the inclination setting means.

By means of kinematics software for simulation of multiple-joint systems, it is possible to swap the drive and the output. In the case of the solution presented, the constant rotational speed of the cushion shell was specified as a drive for the inclination setting means, for example, and, as the result, a graph of the required motor speed was calculated over rotation angle. This graph subsequently forms the basis of the control program for the drive motor.

The rotational speed of the seat setting motors can be closed loop controlled via a PWM (pulse width modulation) controller. It can be reduced and arbitrarily set below its non-closed-loop-controlled rotational speed/torque characteristic. This is achieved in that the voltage is activated and deactivated in rapid succession and, consequently, the rotational speed of the motor is reduced in the same ratio as the switched-on time to the total time. For example, use is made of PWM-controlled motors in backrest setting means so as to be able to switch between rapid backrest pivoting movements for folding over a seat backrest and slow comfort adjustment and keep the setting noises at a constant level. It is also the case that ramping up and ramping down of adjustment movements are common, for example to avoid excessively hard end stops.

One aspect of the present invention may be to program the PWM controller using varying target rotational speeds according to the specified profile of the aforementioned graph. The presently required target rotational speed can be deduced from the respectively present actual position (rotation angle). Since the sequence is repeatedly identical, a lookup table can be stored in the firmware of the control unit in advance. In this way, it is not necessary for calculations to be made during operation, it merely being necessary to take from the table for the present position the associated target value. The motor controlled in this way generates the desired, for example absolutely constant, angular speed at the functional element, for example for the inclination of the cushion shell.

In a further usage case, multiple wobble planetary transmissions may be used in a seat and their motors, for example the motor(s) for the inclination adjustment and the motor(s) for the seat height adjustment, can be driven together in accordance with the present kinematics position. In this case, the PWM control curve can be programmed in a targeted manner in such a way that the wobble planetary transmissions are driven in such a way that the sinusoidal curves of the wobble loops combine in such a way that the amplitudes are eliminated and an almost constant output speed or some other desired profile results.

### DESCRIPTION OF THE FIGURES

The invention is discussed in more detail below on the basis of advantageous exemplary embodiments illustrated in the figures. However, the invention is not limited to these exemplary embodiments. In the figures:

FIG. 1 shows in a schematic illustration a vehicle seat with a longitudinal adjustment device according to the prior art,

FIG. 2 shows a perspective view of a seat part of a vehicle seat according to the invention according to a first exemplary embodiment,

FIG. 3 shows a side view of the seat part of the vehicle seat according to the invention according to the first exemplary embodiment,

FIG. 4 shows a graphical representation of drive parameters and output parameters of the first exemplary embodiment with the motor voltage constant,

FIG. 5 shows a graphical representation of drive parameters and output parameters of the first exemplary embodiment with the motor rotational speed constant,

FIG. 6 shows a graphical representation of drive parameters and output parameters of the first exemplary embodiment under the control method according to the invention,

FIG. 7 shows a schematic illustration of a simulation of the transmission kinematics of a second exemplary embodiment,

FIG. 8 shows a schematic illustration of a simulation of the transmission kinematics of a third exemplary embodiment, and

FIG. 9 shows a graphical representation of drive parameters and output parameters of the third exemplary embodiment under the control method according to the invention.

### DETAILED DESCRIPTION

Parts which correspond to one another are denoted by the same reference signs in all the figures.

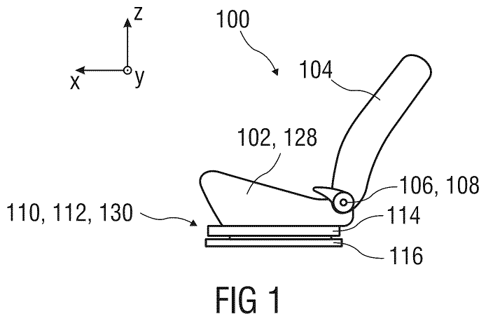

A vehicle seat 100 illustrated schematically in FIG. 1 in relation to the prior art will be described below using three spatial directions which extend perpendicularly to one another. In the case of a vehicle seat 100 installed in the vehicle, a longitudinal direction x extends substantially horizontally and preferably parallel to a vehicle longitudinal direction, which corresponds to the normal direction of travel of the vehicle. A transverse direction y which extends perpendicularly to the longitudinal direction x is likewise oriented horizontally in the vehicle and extends parallel to a vehicle transverse direction. A vertical direction z extends perpendicularly to the longitudinal direction x and perpendicularly to the transverse direction y. In the case of a vehicle seat 100 installed in the vehicle, the vertical direction z preferably extends parallel to a vehicle vertical axis.

The used positional indications and directional indications such as, for example, front, rear, top and bottom relate to a viewing direction of an occupant sitting in the vehicle seat 100 in a normal seating position, wherein the vehicle seat 100 is installed in the vehicle, is in a use position suitable for conveying passengers, with an upright backrest 104, and is oriented in the conventional manner in the direction of travel. The vehicle seat 100 may however also be installed or moved in a different orientation, for example transversely to the direction of travel. Unless described to the contrary, the vehicle seat 100 is constructed in a mirror-symmetrical manner with respect to a plane extending perpendicularly to the transverse direction y.

The backrest 104 may be arranged in a pivotable manner on a seat part 102 of the vehicle seat 100. For this purpose, the vehicle seat 100 may optionally comprise a fitting 106, in particular a setting fitting 106, rotary fitting, latching fitting or wobble fitting.

The used positional indications and directional indications such as, for example, radial, axial and in the circumferential direction relate to an axis of rotation 108 of the fitting 106. Radial means perpendicular to the axis of rotation 108. Axial means in the direction of or parallel to the axis of rotation 108.

The vehicle seat 100 may optionally comprise a longitudinal adjustment device 110.

The longitudinal adjustment device 110 comprises for example a rail arrangement 112 having a first rail element 114 and having a second rail element 116. The first rail element 114 is adjustable relative to the second rail element 116 in the longitudinal direction x. The first rail element 114 is fastened to the seat part 102. The second rail element 116 is fastened to a structural element of a vehicle, for example a vehicle floor.

For improved clarity, the first rail element 114 is referred to in the following description as top rail 114. Said top rail 114 (also referred to as running rail or carriage) is assigned to the vehicle seat 100 and is configured to support said vehicle seat 100. The second rail element 116 is referred to below as bottom rail 116. The bottom rail 116 is fixed and is connected for example to the floor of a vehicle.

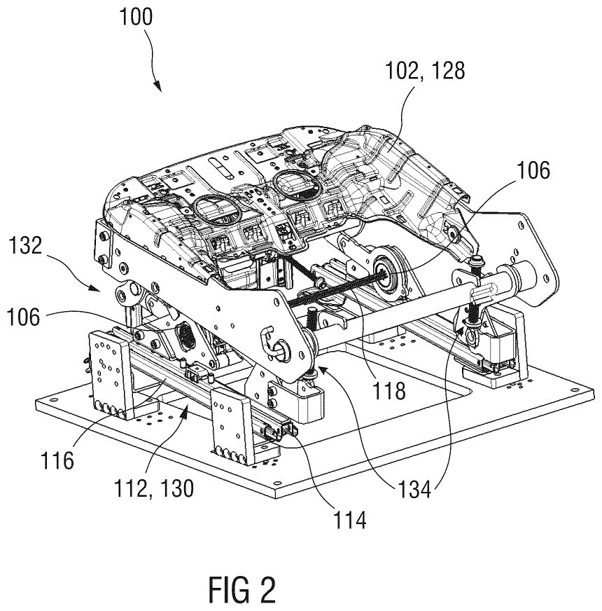

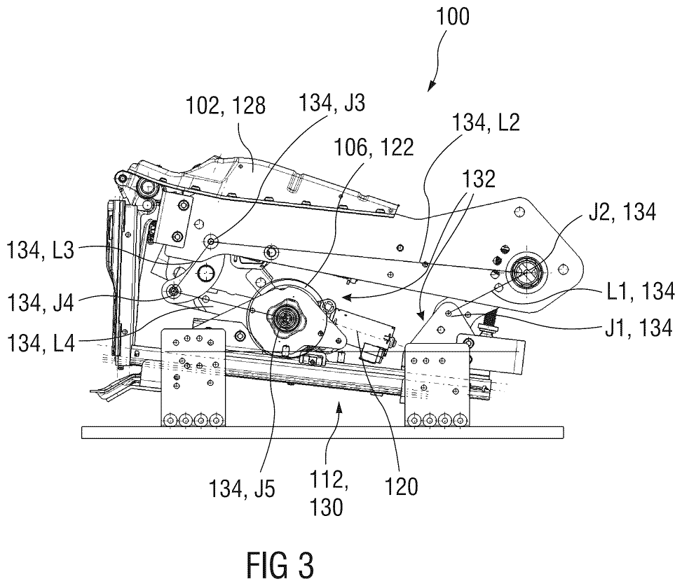

FIG. 2 illustrates a perspective view of a seat part 102 of a vehicle seat 100 according to the invention according to a first exemplary embodiment. FIG. 3 shows a side view of the same seat part 102 of the first exemplary embodiment.

Arranged on the rail arrangement 112, which comprises a top rail 114 and a bottom rail 116, is the vehicle seat 100, of which the seat part 102 is shown in FIG. 1 and FIG. 2, said seat part being connected to the rail arrangement 112 by an adjustment device 132. The adjustment device 132 comprises on each side of the seat part 102 an adjustment mechanism 134, which consists of members L1 . . . . L4 and joints J1 . . . . J5 connecting the members L1 . . . . L4 in an articulated manner, and a setting fitting 106, which serves in the exemplary embodiment as an inclination setting fitting 122 for adjusting the inclination of the seat part 102. The setting fitting 106, 122 is a nonuniformly transmitting wobble transmission. The left-hand and right-hand setting fittings 106, 122 are connected to one another by a coupling shaft 118 and, in this way, are driven synchronously by a drive device 120 in the form of a servo motor.

The adjustment mechanism 134 and the at least one setting fitting 106 together form a kinematic transmission mechanism K. The adjustment mechanism 134 is in particular in the form of a first transmission member K1 and the at least one setting fitting 106 is in the form of a second transmission member K2 of the kinematic transmission mechanism K.

In this exemplary embodiment, the seat part 102 is a first seat component 128, the inclination of which is to be adjusted in an adjustment movement, which is generated by the adjustment device 132, relative to the rail arrangement 112, that is to say a second seat component 130. For setting of the inclination of the seat part 102, the two inclination setting fittings 122 are driven synchronously by the drive device 120 and the coupling shaft 118. The two inclination setting fittings 122 form the joint J5 in their respective adjustment mechanisms 134. The two members L1 and L2 are blocked relative to one another in the joint J2, that is to say they are temporarily connected rigidly to one another. The adjustment mechanism 134 is thus a four-bar linkage mechanism (also referred to as an articulated quadrilateral).

If the inclination setting fittings 122 are driven by the drive device 120 at a constant rotational speed, the nonuniform transmission behavior of the wobble transmission results in a nonuniform adjustment movement of the seat part 102, as described in the introduction. In order to solve this problem, the drive device 120 in the illustrated exemplary embodiment is controlled according to the control method according to the invention, for generating a variable speed dependent on the rotation angle, in such a way that the adjustment device 132 generates an at least approximately uniform adjustment movement of the seat part 102, said adjustment movement being at any rate considerably smoothed in comparison with the prior art.

The drive device 120 is in particular controlled directly by a control device 136 in such a way that it generates a nonuniform drive movement to compensate for the nonuniformity in the kinematic transmission mechanism K. The control device 136 may for example be an integral constituent part of a control unit, for example a motor control unit, of the drive device 120. The control device 136 may alternatively be in the form of a separate control unit.

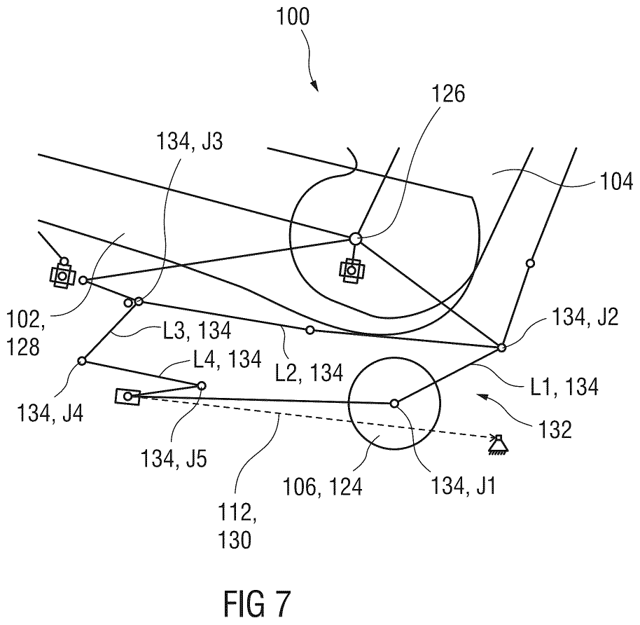

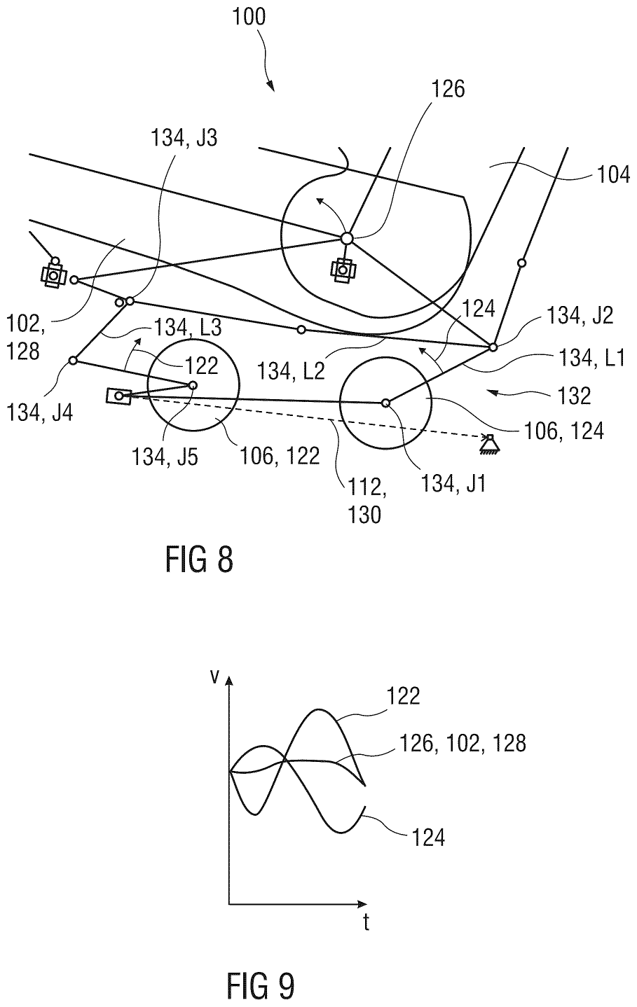

For example, the drive device 120 is controlled directly by the control device 136 in such a way that the nonuniform drive movement generated by the drive device 120 is transmitted to the setting fitting 106, 122, 124 (illustrated in FIGS. 7 and 8) and the setting fitting 106, 122, 124 generates a determined output movement of the adjustment device 132 and thus performs and effects a determined adjustment movement of the first seat component 128, 102.

The setting fittings 106, 122, 124 may each be in the form of a wobble transmission. Also, the adjustment mechanism 134 may be realized by combining two wobble setting fittings.

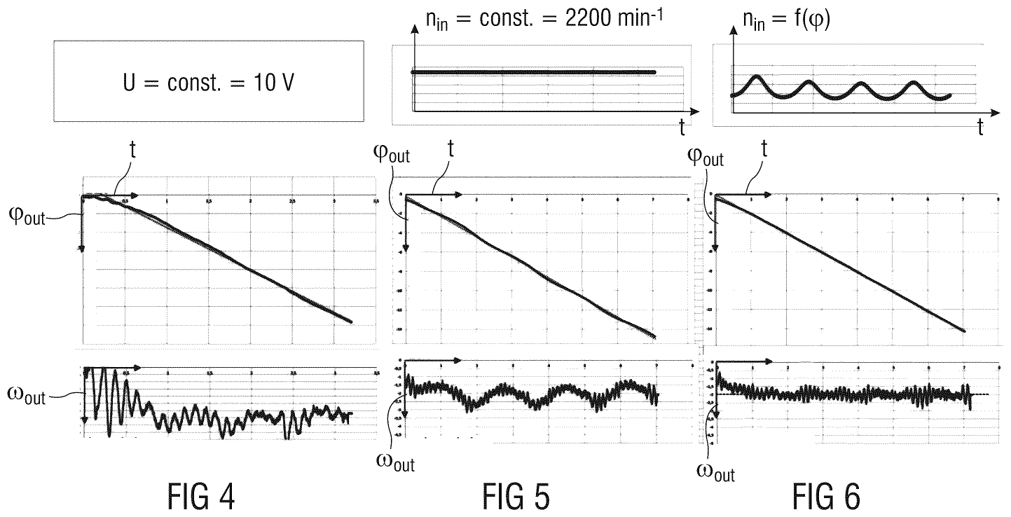

FIG. 4 illustrates a graphical representation of drive parameters and output parameters of the first exemplary embodiment with the motor voltage U constant. In other words, the drive device 120 is not open loop or closed loop controlled in any way, but is simply supplied with a constant voltage U of 10 V. Two diagrams, of which one shows the profile of the output parameter Pout, that is to say the adjustment angle, over time t and the other shows the profile of the output parameter Wout, that is to say the angular speed of the adjustment movement, over time t, are illustrated. It can be clearly seen, particularly at the profile of the angular speed Wout, how nonuniform the adjustment movement is. One reason for this is that the nonuniform transmission of the inclination setting fittings 122 dynamically feeds back to the drive device 120, so that the motor rotational speed varies too.

FIG. 5 shows a graphical representation of drive parameters and output parameters of the first exemplary embodiment with the motor rotational speed constant. In other words, the drive device 120 is closed loop controlled in such a way that the drive parameter motor rotational speed nᵢₙ is constant at 2200 min⁻¹ (2200 rpm), as illustrated in the topmost diagram. Below this, the profiles of the output parameters adjustment angle φₒᵤₜ and angular speed ωₒᵤₜ over time t are again illustrated. In comparison with FIG. 4, it can be seen that the adjustment movement is already considerably more uniform than without motor control because the dynamic feedback to the drive device 120 is compensated by the closed loop control of the motor rotational speed. However, the nonuniform transmission behavior of the inclination setting fittings 122 is still noticeable by virtue of a greatly varying, nonuniform adjustment movement.

FIG. 6 contains a graphical representation of drive parameters and output parameters of the first exemplary embodiment under the control method according to the invention, in which the drive device 120 is subjected to closed loop control on the basis of an inverse transmission function, whereby the motor rotational speed nᵢₙ (and thus the drive angular speed ωᵢₙ proportional thereto) is a periodic function of the adjustment angle φₒᵤₜ, that is to say of the desired adjustment movement. In comparison with FIG. 4 and FIG. 5, it can be seen that the adjustment movement generated in this way is almost ideally uniform, that is to say the adjustment angle φₒᵤₜ changes approximately linearly, so that the angular speed Wout is approximately constant.

In comparison with closed loop control of the drive device 120 yielding a constant motor speed nᵢₙ, as shown in FIG. 5, too, a significant improvement is again achieved, because, according to the method according to the invention, the nonuniform transmission of the inclination setting fittings 122 is compensated. There remain only small variations of the angular speed Wout, caused by tolerances of the moving parts, but the variations are no longer perceived as disturbing in practice.

FIG. 7 and FIG. 8 each show a schematic illustration of simulations of the transmission kinematics of a second and a third embodiment, respectively, these having been produced by way of a kinematics software for simulating the transmission behavior of the illustrated exemplary embodiments.

In the second exemplary embodiment as per FIG. 7, the adjustment device 132 again has an adjustment mechanism 134 formed from members L1 . . . . L4 and joints J1 . . . . J5. At the joint J1, there is arranged a setting fitting 106, which acts here as a height setting fitting 124. The transmission of the adjustment movement to the seat 100, which has a seat part 102 and a backrest 104, is realized at the reference point 126. For ascertaining target values for the drive parameter motor rotational speed nᵢₙ to generate a nonuniform drive movement, an adjustment movement determined to be uniform, for example, is specified as a drive parameter of the simulation at the reference point 126 in the simulation. According to requirement, the determined adjustment movement may additionally have for example a starting ramp at the beginning and a braking ramp at the end of the adjustment movement. The kinematics software uses these specifications to calculate target values for the motor rotational speed nᵢₙ at the joint J1 as output parameter of the simulation. Said target values may be stored, for example in the form of a lookup table, in a control device that controls the drive device 120 at a later stage.

The third exemplary embodiment as per FIG. 8 differs from the second exemplary embodiment as per FIG. 7 in that both a height setting fitting 124 is arranged at the joint J1 and an inclination setting fitting 122 is arranged at the joint J5. According to the method according to the invention, the drive devices 120 are controlled by the inclination setting fitting 122 and the height setting fitting 124 in such a way that their nonuniform transmissions compensate for one another.

FIG. 9 shows this in a graphical representation of output parameters of the third exemplary embodiment under the control method according to the invention. A common speed-time diagram illustrates the output speeds of the inclination setting fitting 122, the height setting fitting 124 and the seat part 102 at the reference point 126 of the adjustment movement. It can be seen that the sinusoidal curves of the wobble loops combine in such a way that the amplitudes are substantially eliminated and an almost constant output speed of the seat part 102 occurs.

### LIST OF REFERENCE SIGNS

100 Vehicle seat
102 Seat part
104 Backrest
106 Fitting, setting fitting
108 Axis of rotation
110 Longitudinal adjustment device
112 Rail arrangement
114 First rail element (top rail)
116 Second rail element (bottom rail)
118 Coupling shaft
120 Drive device
122 Inclination setting fitting
124 Height setting fitting
126 Reference point of the adjustment movement
128 First seat component
130 Second seat component
132 Adjustment device
134 Adjustment mechanism
136 Control device
J1 . . . . J5 Joints
L1 . . . . L4 Members
x Longitudinal direction
y Transverse direction
Z Vertical direction
K Kinematic transmission mechanism
K1 First transmission member
K2 Second transmission member
t Time
U Drive parameter motor voltage
nᵢₙ Drive parameter motor rotational speed
ωᵢₙ Drive parameter angular speed
φₒᵤₜ Drive parameter adjustment angle
ωₒᵤₜ Drive parameter adjustment speed

1. A control method for a vehicle seat having an adjustment device for adjusting a first seat component relative to a second seat component, wherein
the adjustment device comprises an adjustment mechanism and at least one setting fitting that is able to be driven by a drive device, which together form a kinematic transmission mechanism,
wherein the adjustment mechanism is connected operatively to the first seat component and the second seat component and is configured to generate during the operation of the drive device an adjustment movement of the first seat component relative to the second seat component, and
the drive device is controlled by a control device in such a way that nonuniformity in the kinematic transmission mechanism is compensated.

2. The method as claimed in claim 1, wherein the drive device is controlled directly by the control device in such a way that it generates a nonuniform drive movement.

3. The method as claimed in claim 2, wherein the drive device is controlled directly by the control device in such a way that the nonuniform drive movement generated by the drive device is transmitted to the setting fitting and the setting fitting generates a determined output movement of the adjustment device and thus effects a determined adjustment movement of the first seat component.

4. The method as claimed in claim 1, wherein the drive device is controlled by means of pulse width modulation.

5. The method as claimed in claim 2, wherein target values of the nonuniform drive movement are stored in the control device in the form of a lookup table in a manner dependent on actual values of the determined adjustment movement and are used for controlling the drive device.

6. The method as claimed in claim 5, wherein actual values of the determined adjustment movement are ascertained from sensors of the drive device.

7. The method as claimed in claim 1, wherein the drive device is controlled on the basis of an inverse transmission function for the setting fitting and/or for the adjustment mechanism.

8. The method as claimed in claim 7, wherein the inverse transmission function is ascertained by a numerical simulation for the setting fitting and/or the adjustment mechanism in which, on the output side, a determined output movement is specified as an input variable and, on the drive side, target values of the nonuniform drive movement are obtained as an output variable.

9. The method as claimed in claim 1, wherein the drive devices are controlled by at least two nonuniformly transmitting setting fittings, which are constituent parts of the same adjustment mechanism, in such a way that, aside from a nonuniform transmission of one setting fitting, a nonuniform transmission of every other setting fitting and possibly of the adjustment mechanism itself is also compensated.

10. A vehicle seat having an adjustment device for adjusting a first seat component relative to a second seat component, wherein
the adjustment device comprises an adjustment mechanism and at least one setting fitting that is able to be driven by a drive device, which together form a kinematic transmission mechanism,
the adjustment mechanism is connected operatively to the first seat component and the second seat component and is configured to generate during the operation of the drive device an adjustment movement of the first seat component relative to the second seat component, and
the adjustment device comprises a control device, or is connected operatively to a control device, which, in order to compensate for nonuniform transmission of the adjustment device, controls the drive device with a control method in such a way that nonuniformity in the kinematic transmission mechanism is able to be or is compensated.

11. The vehicle seat as claimed in claim 10, wherein the control device is configured to directly control the adjustment device in such a way that said adjustment device generates a nonuniform drive movement.

12. The vehicle seat as claimed in claim 11, wherein the control device is configured to directly control the adjustment device in such a way that the nonuniform drive movement generated by the drive device is transmissible or is transmitted to the setting fitting and the setting fitting generates a determined output movement of the adjustment device and thus effects a determined adjustment movement of the first seat component.
